(19) United States
(12) Patent Application Publication
(10) Pub. No.: US 2026/0341153 A1
(43) Pub. Date: Oct. 29, 2026

(54) VEHICLE CONTROL APPARATUS

(71) Applicants: TOYOTA JIDOSHA KABUSHIKI KAISHA, Aichi (JP); CONTINENTAL AUTONOMOUS MOBILITY GERMANY GMBH, Ingolstadt (DE)

(72) Inventors: Koji TAKEUCHI, Toyota-shi, Aichi-ken (JP); Masanori TOKUDA, Miyoshi-shi, Aichi-ken (JP); Ryuichi SOYA, Yokohama-shi, Kanagawa-ken (JP); Sujeendra Molakalmuru RAGHUNANDANA, Singapore (SG)

(21) Appl. No.: 19/115,252

(22) PCT Filed: Sep. 22, 2023
(86) PCT No.: PCT/JP2023/034578

§ 371 Date: Mar. 26, 2025

(30) Foreign Application Priority Data
Sep. 27, 2022 (JP) 2022-153880

(51) Int. Cl. G08G 1/16; B60W 30/09; G01S 13/931

(52) U.S. Cl. CPC G08G 1/166; B60W 30/09; G01S 13/931; B60W 2420/408; B60W 2554/4041; B60W 2554/802; B60W 2554/804

(57) ABSTRACT

A vehicle control apparatus includes a surrounding sensor detecting a target present around a vehicle; and a control unit executing vehicle control when an approaching target which is a target approaching the vehicle is detected, the vehicle control including vehicle-exit assist control for assisting an occupant of the vehicle in a stopped state in safely exiting the vehicle and collision avoidance assist control for assisting in collision avoidance with the approaching target while the vehicle is stopped or traveling. The control unit is configured to, when a predetermined partial wave condition that is satisfied when the detected target is a partial wave which is a wave constituting a part of water wave of seawater is satisfied for the approaching target, even when an execution condition of the vehicle control is satisfied for the approaching target, not execute or suppress the vehicle control corresponding to the execution condition.

### TECHNICAL FIELD

The present invention relates to a vehicle control apparatus capable of executing vehicle control, including at least one of a vehicle-exit assist control and a collision avoidance assist control.

### BACKGROUND ART

Conventionally, a vehicle control apparatus capable of executing vehicle control, including a vehicle-exit assist control and/or a collision avoidance assist control when an approaching target (a target approaching a vehicle) is detected by surrounding sensors has been known. For example, Patent Literature 1 describes a rear pre-crash safety system capable of executing a control for warning the driver when an approaching target approaching the vehicle from a rear side of the vehicle is detected.

### CITATION LIST

### Patent Literature

[PTL 1] JP 6941190 B2

### SUMMARY OF INVENTION

Now, at a water's edge (beach) of a coast (typically, a sandy beach), water waves of seawater intermittently approach the coast. Therefore, when a vehicle is stopped or traveling at the water's edge, there is a possibility that a vehicle control apparatus recognizes a part of the approaching water waves as an approaching target (that is, a target subject to the vehicle control), leading to unnecessary vehicle control being executed.

The present invention has been made to address the above-mentioned problem. That is, one object of the present invention is to provide a vehicle control apparatus capable of suppressing unnecessary operation of vehicle control in a case in which a vehicle is stopped or traveling at the water's edge.

The vehicle control apparatus according to the present invention (hereinafter referred to as “the present invention apparatus”) includes:
a surrounding sensor capable of detecting a target present around a vehicle; and
a control unit capable of executing vehicle control when an approaching target which is a target approaching the vehicle is detected by the surrounding sensor, the vehicle control including vehicle-exit assist control for assisting an occupant of the vehicle in a stopped state in safely exiting the vehicle and collision avoidance assist control for assisting in collision avoidance with the approaching target while the vehicle is stopped or traveling,
wherein the control unit is configured to, when a predetermined partial wave condition that is satisfied when the detected target is a partial wave which is a wave constituting a part of water wave of seawater is satisfied for the approaching target, even when an execution condition of the vehicle control is satisfied for the approaching target, not execute or suppress the vehicle control corresponding to the execution condition.

The control unit of the present invention apparatus is configured, when the partial wave condition is satisfied for the approaching target detected by the surrounding sensor, not to execute or to suppress the vehicle control (i.e., the vehicle control corresponding to the execution condition) even when the execution condition of the vehicle control is satisfied for the approaching target. Here, the partial wave condition is a condition satisfied when the target is a partial wave (a wave constituting a part of water wave of seawater). With this configuration, it becomes possible to suppress unnecessary operation of the vehicle control in a case in which the vehicle is stopped or traveling at the water's edge. It should be noted that when the vehicle control is the vehicle-exit assist control, the term “execution condition” means an execution condition of the vehicle-exit assist control, and the “vehicle control corresponding to the execution condition” means the vehicle-exit assist control. On the other hand, when the vehicle control is the collision avoidance assist control, the term “execution condition” means an execution condition of the collision avoidance assist control, and the “vehicle control corresponding to the execution condition” means the collision avoidance assist control.

In one aspect of the present invention, a detection region of the surrounding sensor includes a plurality of sets of regions, each set of region including a substantially rectangular first region, a substantially rectangular second region, and a substantially rectangular third region,
in any set, a second long side, which is a long side of the second region, is longer than a first long side, which is a long side of the first region, and the second region is positioned at a position more distant from the vehicle than the first region in such a manner that the entire of the first long side, among a pair of the first long sides of the first region, which is positioned at a distal side which is more distant from the vehicle, is in contact with the second long side, among a pair of the second long sides of the second region, which is positioned at a proximal side which is closer to the vehicle, and a third long side, which is a long side of the third region, is longer than the second long side, and the third region is positioned at a position more distant from the vehicle than the second region in such a manner that the entire of the second long side, among the pair of the second long sides of the second region, which is positioned at the distal side, is in contact with the third long side, among a pair of the third long sides of the third region, which is positioned at the proximal side, and
the control unit is, in any set, configured to:
   in a first case in which a predetermined water wave condition, which is satisfied when water wave is present in at least one of the first region, the second region, or the third region, is satisfied at a current time point and a specific target is present in the first region at the current time point, the specific target being a target satisfying a predetermined specific condition which is satisfied when there is a possibility that a target is the partial wave, determine that the partial wave condition is satisfied for the specific target present in the first region;
   in a second case in which the water wave condition is satisfied at any time point during a predetermined past period from a past time point to a current time point, the specific target is present in the second region or the third region at the any time point, and the specific target which had been present in the second region or the third region at the any time point is present in the first region at the current time point, determine that the partial wave condition is satisfied for the specific target present in the first region; and
   determine that the water wave condition is satisfied in any one of the following cases, that is, a case in which more than or equal to a predetermined first number of the specific targets are present in the first region, a case in which, in the second region, more than or equal to a predetermined second number of the specific targets are present as well as more than or equal to a predetermined third number of the specific targets are present consecutively, each of the specific targets satisfying that an adjacent distance which is a distance to an adjacent specific target is less than or equal to a predetermined second region distance threshold, or a case in which, in the third region, more than or equal to a predetermined four number of the specific targets are present as well as more than or equal to a predetermined fifth number of the specific targets are present consecutively, each of the specific targets satisfying that the adjacent distance is less than or equal to a predetermined third region distance threshold.

According to one aspect of the present invention, the control unit determines, in the first case or the second case, that the partial wave condition is satisfied for the specific target (a target satisfying the specific condition) present in the first region at the current time point. Here, the “first case” is a “case where the water wave condition (a condition satisfied when the water wave is present in at least one of the first region to the third region) is satisfied at the current time point as well as the specific target is present in the first region at the current time point.” On the other hand, the “second case” is a “case in which the water wave condition is satisfied at any time point during the past period, the specific target is present in the second region or the third region at the any time point, and the specific target which had been present in the second region or the third region at the any time point is present in the first region at the current time point”. In these cases, a possibility that the specific target present in the first region is a target other than the partial wave (for example, an other vehicle, a bicycle, and a pedestrian) is extremely low. Therefore, with this configuration, it is possible to determine whether or not a specific target is the partial wave with high accuracy. Accordingly, it is possible to suppress unnecessary operation of the vehicle control as well as to appropriately execute the vehicle control against a target which should be subject to the vehicle control (in other words, it is possible to suppress non-operation of the vehicle control.)

In one aspect of the present invention,
the surrounding sensor is a radar sensor, and
the control unit is configured to determine that the specific condition is satisfied for the target in a case in which a relative speed of the target with respect to the vehicle is less than or equal to a predetermined speed threshold, a radar reflection cross-sectional area of the target is less than or equal to a predetermined cross-sectional area threshold, and a detection time which is a time during which the same target is continuously detected by the surrounding sensor is more than or equal to a predetermined time threshold.

According to one aspect of the present invention, by appropriately setting the speed threshold, the cross-sectional area threshold, and the time threshold, it is possible to make a possibility that the specific condition becomes satisfied at least for other vehicles extremely low. With this configuration, the other vehicles are more likely to be excluded from the specific targets, leading to further improvement in the determination accuracy of whether the target is a partial wave or not.

In the above description, in order to facilitate understanding of the invention, reference symbols used in the embodiment is enclosed in parentheses, and are assigned to each of constituent features of the invention corresponding to the embodiment. However, each of the constituent features of the invention is not limited to the embodiment prescribed by the reference symbols.

### BRIEF DESCRIPTION OF DRAWINGS

FIG. 1 is a schematic configuration diagram of a vehicle control apparatus according to an embodiment of the present invention.

FIG. 2 is a diagram for describing a partial wave condition of vehicle-exit assist control.

FIG. 3 is a flowchart for illustrating a routine executed by CPU of vehicle control ECU.

FIG. 4 is a flowchart for illustrating a partial wave condition determination processing of the routine.

FIG. 5 is a flowchart for illustrating a water wave condition determination processing of the routine.

FIG. 6 is a diagram for describing a positional relationship between a vehicle and first to third regions in a case when a type of vehicle control is FCTA.

### DESCRIPTION OF EMBODIMENTS

### Configuration

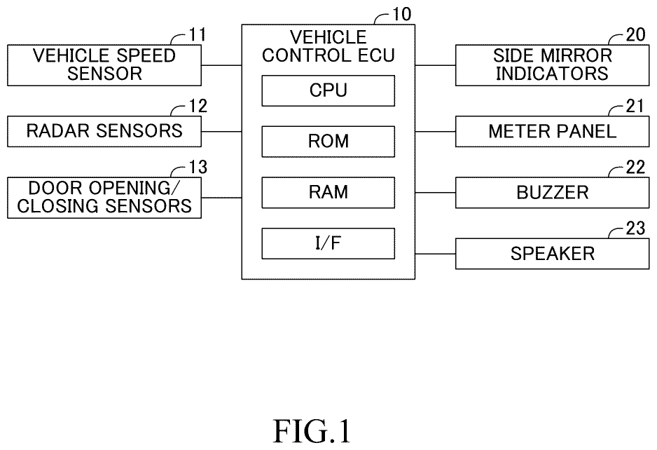

Hereinafter, a vehicle control apparatus (also hereinafter referred to as a “present embodiment apparatus”) according to an embodiment of the present invention is described with reference to figures. The present embodiment apparatus is mounted to a vehicle. As shown in FIG. 1, the present embodiment apparatus includes a vehicle control ECU 10, and a vehicle speed sensor 11, radar sensors 12, door opening/closing sensors 13, side mirror indicators 20, a meter panel 21, a buzzer 22, and a speaker 23, all of which being connected to the vehicle control ECU 10. The vehicle control ECU 10 includes a microcomputer as a main part. The microcomputer includes a CPU, a ROM, a RAM, an interface (I/F), and the like, and the CPU implements various functions by executing instructions (programs and routines) stored in the ROM. Hereinafter, the vehicle to which the present embodiment apparatus is mounted is referred to as an “own vehicle V.”

The vehicle speed sensor 11 generates a signal corresponding to a traveling speed (vehicle speed) of the own vehicle V. The ECU 10 acquires the signal generated by the vehicle speed sensor 11 and calculates the vehicle speed based on the acquired signal.

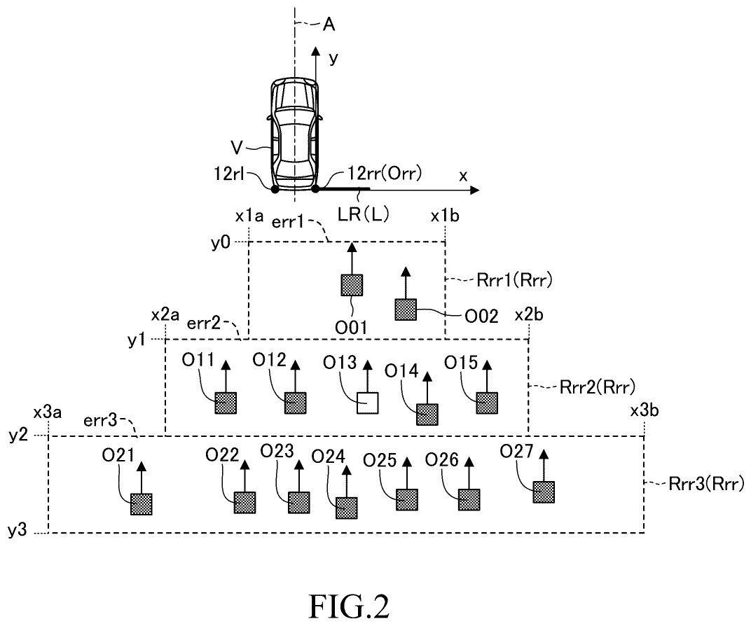

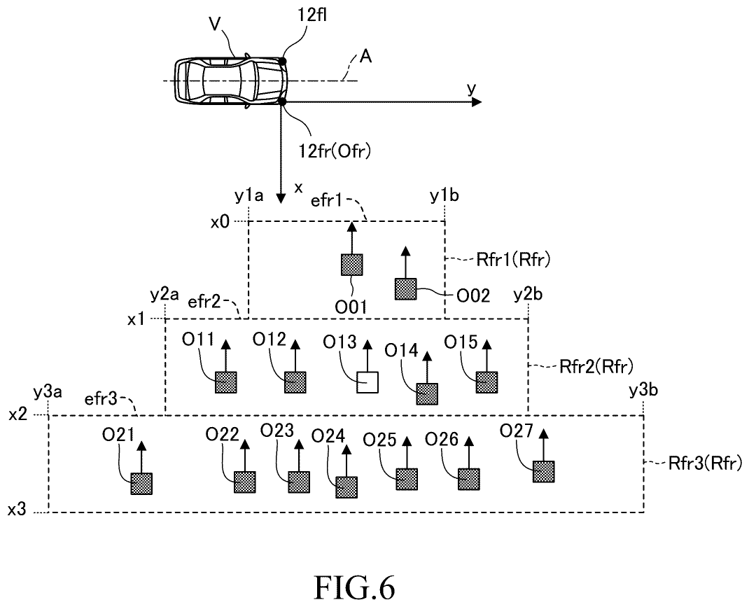

The radar sensors 12 (surroundings sensor) includes a radar sensor 12rl and a radar sensor 12rr (see FIG. 2), and a radar sensor 12fl and a radar sensor 12fr (see FIG. 6). The radar sensors 12rl and 12rr are provided at left and right corners of a rear end of the own vehicle V, respectively. The radar sensors 12fl and 12fr are provided at left and right corners of a front end of the own vehicle V, respectively. The radar sensors 12 emit radio waves in a millimeter wave band around the own vehicle V. Specifically, the radar sensor 12rl emits the radio waves to directly behind and left rear lateral side of the own vehicle V, the radar sensor 12rr emits the radio waves to directly behind and right rear lateral side of the own vehicle V, the radar sensor 12fl emits the radio waves to directly in front and left front lateral side of the own vehicle V, and the radar sensor 12fr emits the radio waves to directly in front and right front lateral side of the own vehicle V. When a three-dimensional object is present within an irradiation range of the radio waves, the radar sensors 12 receive reflected waves from the three-dimensional object. The radar sensors 12 calculate presence/absence of a three-dimensional object and a relative relationship between the own vehicle V and the three-dimensional object (a position, a relative speed, and the like of the three-dimensional object with respect to the own vehicle V) based on the emission timing and the reception timing of the radio waves, and the like. In other words, the radar sensors 12 detect three-dimensional objects present around the own vehicle V. Hereinafter, a three-dimensional object detected by the radar sensors 12 is referred to as a “target.” The radar sensor 12 outputs the information on a target as target information to the ECU 10.

Note that the number and installation positions of the radar sensors 12 are not limited to the above. Additionally, a sensor for acquiring the target information is not limited to the radar sensor 12. For example, instead of or in addition to the radar sensors 12, a laser radar sensor, an ultrasonic sensor, and/or a camera sensor, etc., may be used.

The door opening/closing sensors 13 are provided at respective side doors of the own vehicle V. Each of the door opening/closing sensors 13 generates an open signal when having detected that a door is in an open state, and generates a closed signal when having detected that the door is in a closed state. Based on the signals generated from each of the door opening/closing sensors 13, the ECU 10 determines an open or closed state of the corresponding door.

The side mirror indicators 20 are provided at respective predetermined positions of left and right side mirrors of the own vehicle V, and independently turns on or off with each other. The meter panel 21 is arranged at directly in front of a driver's seat of the own vehicle V (a position from which a driver can visually recognize). The buzzer 22 is built into the meter panel 21. The speaker 23 is a component of a navigation system (not shown) and is provided in the vicinity of a non-illustrated touch panel display.

### Operation Detail

Next, operation detail of the ECU 10 is described. The ECU 10 is configured to be capable of executing a vehicle control including a vehicle-exit assist control and a collision avoidance assist control. The vehicle-exit assist control is a control for assisting an occupant of the own vehicle V in a stopped state in safely exiting the own vehicle V when a rear-approaching target (a target approaching from rear of the own vehicle V) is detected. The collision avoidance assist control is a control for, when an approaching target is detected while the own vehicle V is stopped or traveling, assisting in collision avoidance with the target.

In this embodiment, the collision avoidance assist control includes FCTA (Front Cross Traffic Alert), RCTA (Rear Cross Traffic Alert), and BSM (Blind Spot Monitor). The FCTA is a control for, when a cross-approaching target is detected while the own vehicle V is stopped or progressing at a low vehicle speed, executing an alert control for alerting the driver of the own vehicle V to a presence of the target, and/or a braking control for automatically applying braking force to the own vehicle V. Here, the cross-approaching target is a target approaching the own vehicle V from a direction crossing with a traveling direction of the own vehicle V (when the own vehicle V is in a stopped state, an estimated traveling direction estimated based on a shift lever position). The RCTA is a control for executing the alert control and/or the braking control when the cross-approaching target is detected while the own vehicle V is stopped or recessing at a low vehicle speed. The BSM is a control for executing the alert control when the rear-approaching target (strictly, a target approaching a blind spot region of the own vehicle V from rear).

Now, at a water's edge (beach) of a coast, water waves of seawater intermittently approach the coast. Therefore, in the related art, when a vehicle is stopped or traveling at the water's edge, there is a possibility that a part of the approaching water waves is recognized as an approaching target, leading to unnecessary vehicle control being executed.

In view of the above, in this embodiment, the ECU 10 is configured to determine whether or not a partial wave condition is satisfied for an approaching target, and when satisfied, not to execute the vehicle control even when an execution condition of the vehicle control is satisfied for the approaching target. Here, the partial wave condition is a condition satisfied when a target is a “wave constituting a part of the water waves of seawater (hereinafter referred to as a “partial wave”).” In the following, a description is made by taking the vehicle-exit assist control among the vehicle control as an example. In this embodiment, the ECU 10 executes the alert control as the vehicle-exit assist control.

The execution condition A of the vehicle-exit assist control is satisfied when all of the following conditions 1 to 3 are satisfied.

(Condition 1) The own vehicle V is stopped (in a stopped state).

(Condition 2) An interference target is detected.

(Condition 3) The door of the own vehicle V is in an open state.

First, a description is made on the condition 1. The ECU 10 determines that the condition 1 is satisfied when the vehicle speed acquired from the vehicle speed sensor 11 is zero.

Next, a description is made on the condition 2. An interference target is a rear-approaching target that is likely to interfere with a safe vehicle-exit of the occupant (in other words, pass on a lateral side of the own vehicle V). When a target is detected by the radar sensors 12 (specifically, the radar sensors 12rl and 12rr), the ECU 10 calculates a predicted time (TTC: Time To Collision) predicted to be required for the target to come in contact with or reach a position closest to the own vehicle V. When the TTC is less than or equal to a predetermined time threshold TTCth, the ECU 10 detects the target as an interference target and determines that the condition 2 is satisfied.

The TTC can be calculated as follows. That is, when the condition 1 is satisfied, the ECU 10 sets an xy-coordinate system (left-side xy-coordinate system) having the installation position of the radar sensor 12rl as an origin Orl, and an xy-coordinate system (right-side xy-coordinate system) having the installation position of the radar sensor 12rr as an origin Orr (in FIG. 2, only the latter coordinate system is illustrated.) As shown in FIG. 2, an x-axis extends in a vehicle width direction (left-right direction) of the own vehicle V such that a vehicle width rightward direction points to a +x-axis direction. A y-axis extends in a front-rear direction of the own vehicle V such that a forward direction points to a +y-axis direction.

Subsequently, the ECU 10 sets an intersecting determination line L. The intersecting determination line is a virtual line set to calculate the TTC, and includes a left-side intersecting determination line LL and a right-side intersecting determination line LR. The left-side intersecting determination line LL extends in a-x-axis direction from the origin Orl, while the right-side intersecting determination line LR extends in the +x-axis direction from the origin Orr (in FIG. 2, only the right-side intersecting determination line LR is illustrated). Lengths of the left and right intersecting determination lines LL and LR are the same as each other (for example, approximately 1.3 m).

Next, the ECU 10 calculates a speed vector of the target based on the target information, and sets a start point thereof to a proximate portion of the target (a portion of a front end portion of the target that is closest to the own vehicle V in the x-axis direction). Note that arrows extending respectively from a plurality of targets O (described later) shown in FIG. 2 are arrows indicating traveling directions of the respective targets O and are not arrows indicating the speed vectors. When an extension line of the speed vector of the target intersects with either one of the left or right intersecting determination lines LL or LR, the ECU 10 calculates a “predicted time required for the target to intersect with the intersecting determination line L” as the TTC.

When the TTC for the left-side intersecting determination line LL is less than or equal to TTCth, the ECU 10 detects the target as an interference target for the door on the left side. On the other hand, when the TTC for the right-side intersecting determination line LR is less than or equal to TTCth, the ECU 10 detects the target as an interference target for the door on the right side. In these cases, the ECU 10 determines that the condition 2 is satisfied. In contrast, when the TTC is greater than TTCth or when the extension line of the speed vector of the target does not intersect with the intersecting determination line L, the ECU 10 determines that the condition 2 is not satisfied.

Moreover, a description is made on the condition 3. When the ECU 10 determines that the door on the side which the interference target is detected is in the open state based on the signal acquired from the door opening/closing sensor 13, the ECU 10 determines that the condition 3 is satisfied (in other words, the occupant has a vehicle-exit intention).

Furthermore, a description is made on the vehicle-exit assist control (alert control). When the execution condition A is satisfied, the ECU 10 executes the following processing 1 to 4 as the vehicle-exit assist control:

(Processing 1) Turn on the side mirror indicator 20 on the side which the interference target is detected.

(Processing 2) Display a predetermined mark (for example, a mark for clearly indicating from which direction of the left rear side or the right rear side the interference target is approaching) on the meter panel 21.

(Processing 3) Sound the buzzer 22.

(Processing 4) Cause the speaker 23 to utter a predetermined message (for example, a message of “warning, approaching vehicle”).

It should be noted that processing executed as the vehicle-exit assist control (alert control) is not limited to the processing above. For example, the ECU 10 may be configured to execute at least one of the processing 1 to 4.

Next, a description is made on the partial wave condition. When a target is detected by the surrounding sensors, the ECU 10 determines whether or not the target satisfies a predetermined specific condition. The specific condition is satisfied when all of the following conditions a to c are satisfied.

(Condition a) A relative speed of the target with respect to the own vehicle V is less than or equal to a predetermined speed threshold.

(Condition b) A radar reflection cross-sectional area of the target is less than or equal to a predetermined cross-sectional area threshold.

(Condition c) A detection time of the target (a time during which the same target is continuously detected/a lifecycle) is more than or equal to a predetermined time threshold.

The speed threshold, the cross-sectional area threshold, and the time threshold mentioned above are respectively set to such values that the conditions a to c are more likely to be satisfied when the target is a partial wave and less likely to be satisfied when the target is an other vehicle. Therefore, the specific condition can also be described as a “condition satisfied when there is a possibility that the target is a partial wave.” Hereinafter, a target that satisfies the specific condition is referred to as a “specific target.”

The ECU 10 sets a set of a region Rrl and a set of a region Rrr at a diagonally left rear side and a diagonally right rear side of the own vehicle V, respectively (in FIG. 2, only the region Rrr is illustrated). The Regions Rrl and Rrr are both included in the detection regions of the radar sensors 12rl and 12rr. As shown in FIG. 2, the region Rrr includes a region Rrr1 (first region), a region Rrr2 (second region), and a region Rrr3 (third region). The region Rrr1, the region Rrr2, and the region Rrr3 all have substantially rectangular shapes. In the right-side xy coordinate system, the region Rrr1 satisfies x1a<x<x1b and y1<y<y0, where x1a<0, x1b>0, and y0<0 are satisfied. Also, x1a is greater than the length of the right-side intersecting determination line LR. The region Rrr2 satisfies x2a<x<x2b and y2<y<y1, where x2a<x1a and x2b>x1b are satisfied. The region Rrr3 satisfies x3a<x<x3b and y3<y<y3, where x3a<x2a and x3b>x2b. That is, among a long side err1 (first long side) of the region Rrr1, a long side err2 (second long side) of the region Rrr2, and a long side err3 (third long side) of the region Rrr3, a relationship of err1<err2<err3 is established. The region Rrr2 is positioned at a position more distant from the own vehicle V than the region Rrr1. An entire long side err1 on a −y axis direction side (a distal side more distant from the own vehicle V) is in contact with a long side err2 on a +y axis direction side (a proximal side closer to the own vehicle V). Similarly, the region Rrr3 is positioned at a position more distant from the own vehicle V than the region Rrr2. An entire long side err2 on the −y axis direction side is in contact with a long side err3 on the +y axis direction side. The region Rrr is set at a position at which a rear-approaching target from the right rear lateral side is detectable.

The region Rrl (not shown) includes a region Rrl1 (first region), a region Rrl2 (second region), and a region Rrl3 (third region). The region Rrl is arranged so as to be symmetric to the region Rrr with respect to the front-rear axis A of the own vehicle V (see FIG. 2). Therefore, a description on the region Rrl is omitted.

The ECU 10 determines that the partial wave condition is satisfied for a specific target present in the region Rrr1 when either the first condition or the second condition below is satisfied.

(First condition) A predetermined water wave condition (described later) is satisfied at a current time point, and a specific target is present in the region Rrr1 at the current time point.

(Second condition) The water wave condition had been satisfied at any time point t during a predetermined past period, and a specific target had been present in the region Rrr2 or the region Rrr3 at the time point t, and the specific target which had been present in the region Rrr2 or the region Rrr3 at the time point t is present in the region Rrr1 at the current time point.

First, a description is made on the water wave condition. The water wave condition is satisfied when at least one of the following conditions 1w to 3w is satisfied:

(Condition 1w) The number N1 of specific targets in the region Rrr1 is more than or equal to N1th (first number).

(Condition 2w) The number N2 of specific targets in the region Rrr2 is more than or equal to N2th (second number), and the number N2d of specific targets which satisfy a distance condition 2wd (described later) and are present consecutively is more than or equal to N2dth (third number).

(Condition 3w) The number N3 of specific targets in the region Rrr3 is more than or equal to N3th (fourth number), and the number N3d of specific targets which satisfy a distance condition 3wd (described later) and are present consecutively is more than or equal to N3dth (fifth number).

It should be noted that the distance condition 2wd is a condition satisfied when a distance (adjacent distance) d to another adjacent specific target in the region Rrr2 is less than or equal to a predetermined distance threshold d2th. The distance condition 3wd is a condition satisfied when the adjacent distance d in the region Rrr3 is less than or equal to a predetermined distance threshold d3th. The large/small relationship between d2th and d3th is not particularly limited.

Here, the water wave of seawater is surface wave generated by a movement of seawater mainly near water surface, and is generated by surface tension and gravity acting as restoring force. Water waves are elongated in a direction substantially orthogonal to a traveling direction thereof. When the radio waves are irradiated from the radar sensors 12 towards a sea side, the radar sensors 12 detects a plurality of partial waves as individual targets (i.e., specific targets) based on a reflection intensity distribution and the like of the radio waves reflected at a wavefront of the water wave. The positions and the sizes of the regions Rrrn (n: 1, 2, 3), the thresholds N1th to N3th, N2dth, N3dth, d2th, and d3th are respectively set to such values that each of the conditions 1w to 3w is more likely to be satisfied when the water wave is present in the regions Rrrn and less likely to be satisfied when the water wave is not present in the regions Rrrn. Therefore, the water wave condition can be described as a “condition satisfied when the water wave is present in at least one of the regions Rrr1, Rrr2, or Rrr3.” In the example of FIG. 2, two specific targets O01 and O02 are detected in the region Rrr1, four specific targets O11, O12, O14, and O15, and one target (a target not satisfying the specific condition) O13 are detected in the region Rrr2, and seven specific targets O21 to O27 are detected in the region Rrr3. In the region Rrr2, the adjacent distance d between the specific targets O11 and O12, and the adjacent distance d between the specific targets O14 and O15 are both less than or equal to the distance threshold d2th, but the adjacent distance d between the specific targets O12 and O14 is greater than the distance threshold d2th. Therefore, N2d=2. In the region Rrr3, the adjacent distances d of the specific targets O22 to O27 are all less than or equal to the distance threshold d3th, but the adjacent distance d between the specific targets O21 and O22 is greater than the distance threshold d3th. Therefore, N3d=6. When defining that N1th=3, N2th=4, N2dth=3, N3th=5, and N3dth=4, N1 (=2) is less than N1th and thus the condition 1w is not satisfied. In addition, although N2 (=4) is more than or equal to N2th, N2d is less than N2dth and thus the condition 2w is not satisfied. In contrast, N3 (=7) is greater than N3th and N3d is greater than N3dth, and thus the condition 3w is satisfied. Accordingly, in the example of FIG. 2, the ECU 10 determines that the water wave condition is satisfied (the water wave is present in the region Rrr3).

Subsequently, a description is made on the first condition. The first condition consists of two conditions of a “condition 1a that the water wave condition is satisfied at a current time point,” and a “condition 1b that a specific target is present in the region Rrr1 at the current time point.” It may happen that the condition 1b is satisfied by a bicycle or a pedestrian (or in some cases, an other vehicle) that is present in the region Rrr1 at the current time point satisfying the specific condition, but a possibility that the condition 1a is satisfied is extremely low because a possibility that the water wave condition is satisfied on a road is extremely low. Therefore, in a case when a specific target is a target other than the partial wave, a possibility that the first condition is satisfied is extremely low. On the other hand, in a case when a specific target is the partial wave, the possibility that the first condition is satisfied is extremely high. Hence, by setting up the first condition in this way, it is possible to determine whether or not a specific target is the partial wave with high accuracy. Note that a phrase “when the first condition is satisfied” corresponds to an example of a “first case.” Next, a description is made on the second condition. The second condition consists of three conditions of a “condition 2a that the water wave condition is satisfied at any time point t during the past period (a period from a past time point which is past by a predetermined period Tth from the current time point to the current time point),” a “condition 2b that a specific target is present in the regions Rrr2 or Rrr3 at the time point t,” and a “condition 2c that the specific target that had been present in the regions Rrr2 or Rrr3 at the time point t is present in the region Rrr1 at the current time point.” It may happen that the conditions 2b and 2c are satisfied by a bicycle or a pedestrian (or in some cases, an other vehicle) that had been present in the regions Rrr2 or Rrr3 at the time point t satisfying the specific condition and by such a specific target traveling to be present in the region Rrr1 at the current time point. However, a possibility that the condition 2a is satisfied is extremely low because the possibility that the water wave condition is satisfied on a road is extremely low. Therefore, in a case when a specific target is a target other than the partial wave, a possibility that the second condition is satisfied is extremely low. On the other hand, in a case when a specific target is the partial wave, the possibility that the second condition is satisfied is extremely high. Hence, by setting up the second condition in this way, it is possible to determine whether or not a specific target is the partial wave with high accuracy. Note that a phrase “when the second condition is satisfied” corresponds to an example of a “second case.” In the example of FIG. 2, the condition 1a is satisfied because the water waves are present in the region Rrr3 at the current time point. Also, the condition 1b is satisfied because two specific targets O01 and O02 are present in the region Rrr1 at the current time point. Therefore, the ECU 10 determines that the partial wave condition is satisfied for the specific targets O01 and O02. It should be noted that the ECU 10 is configured not to perform the determination of the second condition when the water wave condition is satisfied at the current time point.

Regarding the partial wave condition for the region Rrl, a description can be made by replacing “rr” in the description above with “rl”. This is the description on the partial wave condition.

The ECU 10 determines whether the partial wave condition is satisfied for all the targets detected by the surrounding sensors. When a target that satisfies the execution condition A is detected, the ECU 10 determines whether the partial wave condition is (determined to be) satisfied for that target. When the partial wave condition is not satisfied, the ECU 10 determines that the target should be subject to the vehicle-exit assist control and executes the vehicle-exit assist control. When the partial wave condition is satisfied, the ECU 10 determines that the target is a partial wave and does not execute the vehicle-exit assist control for that target. With this configuration, it is possible to suppress unnecessary operation of the vehicle-exit assist control in a case in which the own vehicle V is stopped at the water's edge.

### Specific Operation

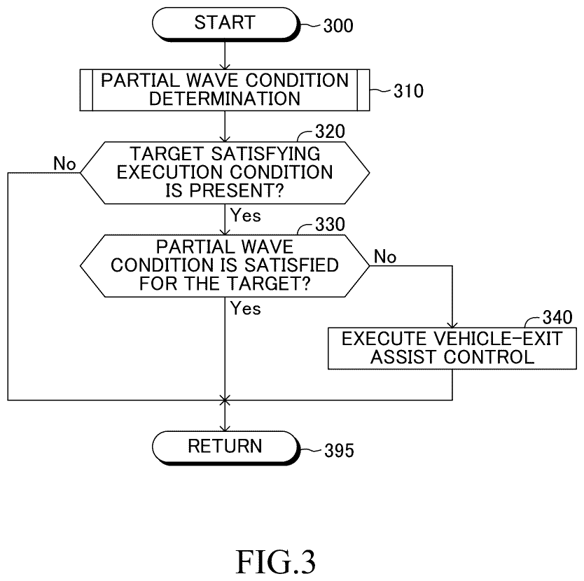

Next, a description is made on specific operation of the ECU 10. Hereinafter, a description is made on the operation of determining whether to execute the vehicle-exit assist control for a target detected in the region Rrr. The CPU of the ECU 10 executes routines shown by flowcharts of FIG. 3 to FIG. 5 during a period when the vehicle V is stopped (during a period when the condition 1 is satisfied). Note that regarding operation of determining whether to execute the vehicle-exit assist control for a target detected in the region Rrl, a description can be made by replacing “rr” in the following description with “rl”.

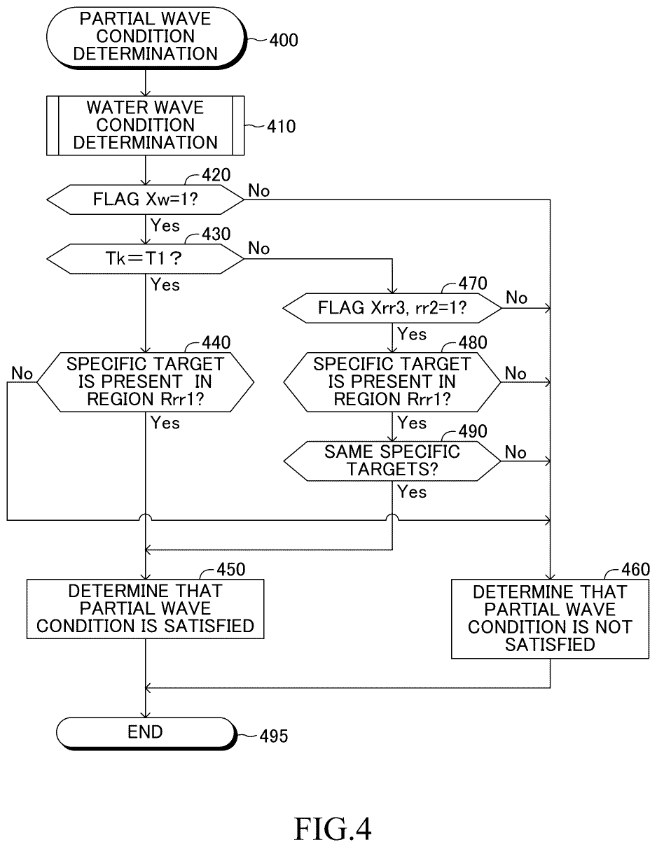

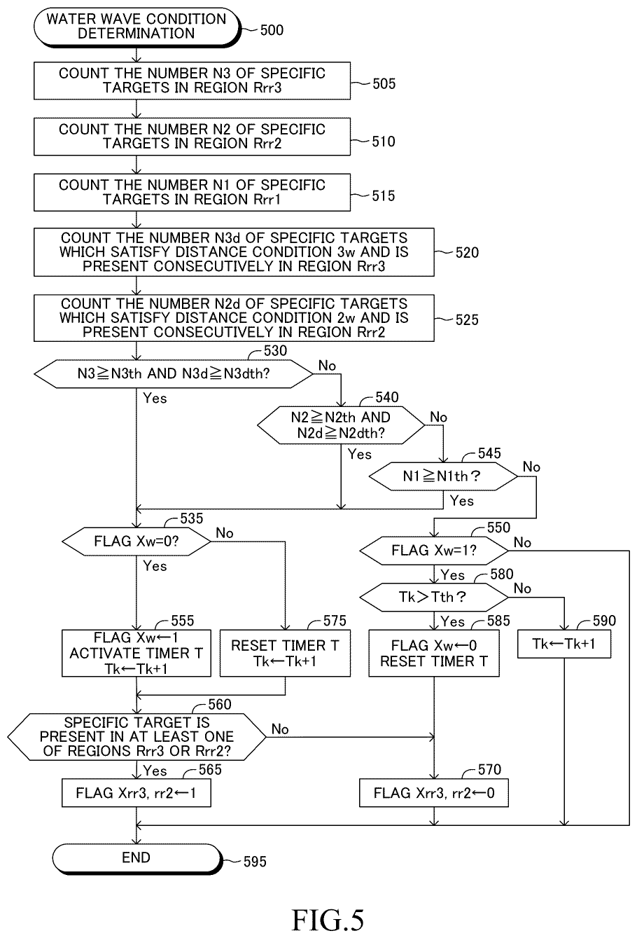

At a specific timing, the CPU proceeds with processing from step 300 of FIG. 3 to step 310, and executes the partial wave condition determination. Specifically, the CPU proceeds with processing from step 400 of FIG. 4 to step 410 to execute the water wave condition determination. That is, the CPU initiates processing from step 500 of FIG. 5 and executes the following processing of step 505 to step 525.

Step 505: Count the number N3 of specific targets in the region Rrr3.

Step 510: Count the number N2 of specific targets in the region Rrr2.

Step 515: Count the number N1 of specific targets in the region Rrr1.

Step 520: Count the number N3d of specific targets in the region Rrr3 which satisfy the distance condition 3wd and are present consecutively.

Step 525: Count the number N2d of specific targets in the region Rrr2 which satisfy the distance condition 2wd and are present consecutively.

Subsequently, the CPU proceeds with processing to step 530 and determines whether N3≥N3th and N3d≥N3dth are satisfied. When N3≥N3th and N3d≥N3dth (S530: Yes), the CPU determines that the condition 3w is satisfied and proceeds with processing to step 535. On the other hand, when N3<N3th or N3d<N3dth (S530: No), the CPU determines that the condition 3w is not satisfied and proceeds with processing to step 540.

In step 540, the CPU determines whether N2>N2th and N2d>N2dth are satisfied. When N2>N2th and N2d>N2dth (S540: Yes), the CPU determines that the condition 2w is satisfied and proceeds with processing to step 535. On the other hand, when N2<N2th or N2d<N2dth (S540: No), the CPU determines that the condition 2w is not satisfied and proceeds with processing to step 545.

In step 545, the CPU determines whether N1>N1th is satisfied. When N1>N1th (S545: Yes), the CPU determines that the condition 1w is satisfied and proceeds with processing to step 535. On the other hand, when N1<N1th (S545: No), the CPU determines that the condition 1w is not satisfied and proceeds with processing to step 550.

In step 535, the CPU determines whether a flag Xw is equal to 0. The flag Xw is a flag related to the water wave condition. When the water wave condition is satisfied, a value of the flag Xw is set to 1. The value of the flag Xw is maintained from a time point at which the water wave condition has been satisfied to a time point at which a period Tth (i.e., the same period as the past period) has elapsed, and is thereafter switched to 0 after the period Tth has elapsed. When the water wave condition has been satisfied again in the midst of the period Tth having elapsed, the value of the flag Xw is maintained from a time point at which the water wave condition has been satisfied again to the time point at which the period Tth has elapsed. A value of the flag Xw in an initial state is 0.

When the flag Xw is equal to 0 (S535: Yes), the CPU determines that the water wave condition has been satisfied for the first time at the current cycle (at the current time point) throughout the past period, and proceeds with processing to step 555 to set the value of the flag Xw to 1. Besides, the CPU activates a timer T and starts to count up. Thereafter, the CPU proceeds with processing to step 560. On the other hand, when the flag Xw is equal to 1 (S535: No), the CPU determines that the water wave condition had been satisfied at any time point t during the past period, and proceeds with processing to step 575 to reset the timer T, and starts to count up again. Thereafter, the CPU proceeds with processing to step 560.

In step 560, the CPU determines whether a specific target is present in at least one of the region Rrr3 or the region Rrr2. When the specific target is present in the region Rrr3 or the region Rrr2 (S560: Yes), the CPU proceeds with processing to step 565 and sets a value of a flag Xrr3,rr2 to 1. On the other hand, when there is no specific target present in the region Rrr3 or the region Rrr2 (S560: No), the CPU proceeds with processing to step 570 and sets the value of the flag Xrr3,rr2 to 0. That is, the flag Xrr3,rr2 is a flag indicating whether a specific target is present in the region Rrr3 or the region Rrr2 at the time point at which the water wave condition has been satisfied. When there is the specific target present, the value of the flag Xrr3,rr2 is set to 1, and when there is no specific target present, the value of the flag Xrr3,rr2 is set to 0. This value is used for determining whether the condition 2w is satisfied (described later). After completing the processing of step 565 or step 570, the CPU proceeds with processing to step 595 and tentatively terminates the present routine.

On the other hand, when the flag Xw is equal to 0 (S550: No), the CPU determines that the water wave condition was not satisfied during the past period, either and proceeds with processing to step 595 to tentatively terminate the present routine. On the other hand, when the flag Xw is equal to 1 (S550: Yes), the CPU determines that although the water wave condition is not satisfied at the current time point, the water wave condition had been satisfied at the time point t during the past period, and proceeds with processing to step 580. In step 580, the CPU determines whether a value Tk of the timer T exceeds a value Tth.

When Tk is less than or equal to Tth (S580: No), the CPU determines that the period Tth has not yet elapsed since the time point t, and proceeds with processing to step 590 to continue the count up of the timer T. At this time, the value of the flag Xrr3,rr2 is maintained. Thereafter, the CPU proceeds with processing to step 595 to tentatively terminates the present routine. On the other hand, when Tk is greater than Tth (S580: Yes), the CPU determines that the period Tth has elapsed since the time point t, and proceeds with processing to step 585. In step 585, the CPU sets the value of the flag Xw to 0 (initialization) and resets the timer T. Thereafter, the CPU proceeds with processing to step 570 to set the value of the flag Xrr3,rr2 to 0 (initialization), and proceeds with processing to step 595 to tentatively terminate the present routine.

Next, the CPU proceeds with processing to step 420 of FIG. 4 through step 595 and determines whether the flag Xw is equal to 1. When the flag Xw is equal to 0 (S420: No), the CPU determines that either the first condition or the second condition is not satisfied, and proceeds with processing to step 460 to determine that the partial wave condition is not satisfied for all the detected targets.

In contrast, when the flag Xw is equal to 1 (S420: Yes), the CPU proceeds with processing to step 430 to determine whether Tk is equal to T1. When Tk is equal to T1 (S430: Yes), the CPU determines that the condition 1a is satisfied, and proceeds with processing to step 440 to determine whether a specific target is present in the region Rrr1. When the specific target is present in the region Rrr1 (S440: Yes), the CPU determines that the condition 1b is satisfied, and proceeds with processing to step 450 to determine that the partial wave condition is satisfied for the specific target (due to the satisfaction of the first condition). On the other hand, when no specific target is present in the region Rrr1 (S440: No), the CPU determines that the condition 1b is not satisfied and proceeds with processing to step 460.

In contrast, when Tk is not equal to T1 (S430: No), the CPU determines that the condition 2a is satisfied, and proceeds with processing to step 470 to determine whether the flag Xrr3,rr2 is equal to 1. When the flag Xrr3,rr2 is equal to 1 (S470: Yes), the CPU determines that the condition 2b is satisfied, and proceeds with processing to step 480 to determine whether a specific target is present in the region Rrr1 at the current time point. When the specific target is present in the region Rrr1 (S480: Yes), the CPU proceeds with processing to step 490. In step 490, the CPU determines whether the specific target that had been present in the regions Rrr3 or Rrr2 at a time point when the value of the flag Xrr3,rr2 was switched from 0 to 1 is the same as the specific target present in the region Rrr1 at the current time point. When these specific targets are the same (S490: Yes), the CPU determines that the condition 2c is satisfied, and proceeds with processing to step 450 to determine that the partial wave condition is satisfied for this specific target (due to the satisfaction of the second condition). Note that in step 450, the CPU determines that the partial wave condition is not satisfied for targets other than the specific target present in the region Rrr1.

On the other hand, when the flag Xrr3,rr2 is equal to 0 in step 470 (S470: No), when there is no specific target present in the region Rrr1 in step 480 (S480: No), or when these specific targets are not the same in step 490 (S490: No), the CPU determines that the conditions 2b and/or 2c are not satisfied and proceeds with processing to step 460.

After completing the processing of step 450 or step 460, the CPU proceeds with processing to step 495 and tentatively terminates the present routine.

Next, the CPU proceeds with processing to step 320 of FIG. 3 through step 495 and determines whether a target satisfying the execution condition A is present. When there is no target satisfying the execution condition A (S320: No), the CPU proceeds with processing to step 395 to tentatively terminate the present routine. On the other hand, when the target satisfying the execution condition A is present (S320: Yes), the CPU proceeds with processing to step 330 to determine whether the partial wave condition is satisfied for that target. When the partial wave condition is satisfied (S330: Yes), the CPU proceeds with processing to step 395 and tentatively terminate the present routine. That is, the vehicle-exit assist control is not executed. On the other hand, when the partial wave condition is not satisfied (S330: No), the CPU proceeds with processing to step 340 to execute the vehicle-exit assist control for that target. Thereafter, the CPU proceeds with processing to step 395 and tentatively terminate the present routine.

In addition, the present embodiment apparatus executes the collision avoidance assist control in addition to the vehicle-exit assist control. The ECU 10 sets a set of the region R, including the region R1 (first region), the region R2 (second region), and the region R3 (third region), at a predetermined position depending on the types of the vehicle control. FIG. 6 is a figure for illustrating a positional relationship between the own vehicle V and a set of a region Rfr in a case when the type of the vehicle control is FCTA. As shown in FIG. 6, as a coordinate system corresponding to the region Rfr, the right-side xy coordinate system is set with the installation position of the radar sensor 12fr as an origin Ofr. The region Rfr includes a region Rfr1 (first region), a region Rfr2 (second region), and a region Rfr3 (third region). Values of each coordinate x0 to x3 and y1a, y1b, y2a, y2b, y3a, and y3b that define these regions are set such that the region Rfr can detect a cross-approaching target from a right side. Among long sides efr1, efr2, and efr3, a relationship of efr1<efr2<efr3 is established. Note that although not shown in FIG. 6, when the type of the vehicle control is FCTA, a set of a region Rfl is also set at a position where a cross-approaching target from a left side can be detected. The region Rfl is arranged so as to be symmetric to the region Rfr with respect to the front-rear axis A. Furthermore, when the type of the vehicle control is RCTA, a set of a region R_rcta is set at a predetermined position where a cross-approaching target from the left and right sides can be detected (illustration omitted). Additionally, when the type of the vehicle control is BSM, a set of a region R_bsm is set at a predetermined position where a rear-approaching target can be detected (illustration omitted).

In the above, the vehicle control apparatus according to the embodiment has been described, but the present invention is not limited to the above-mentioned embodiment, and various changes are possible within the range not departing from the object of the present invention.

For example, the vehicle control apparatus may be configured to be capable of executing either one of the vehicle-exit assist control or the collision avoidance assist control (FCTA, RCTA, BSM) as the vehicle control. Additionally, the vehicle control apparatus may be configured to suppress the vehicle control (reduce a degree of the vehicle control). Furthermore, the vehicle control apparatus may execute a door opening limiting control for limiting a degree of the opening of the door or a door lock control for locking the door as the vehicle-exit assist control instead of or in addition to the alert control. The present invention can also be applied to vehicles (so-called autonomous vehicles) that travel by autonomous driving (autonomous driving control) (typically, as for a configuration in which braking control is executed by FCTA and/or RCTA).

### Reference Signs List

10: vehicle control ECU, 11: vehicle speed sensor, 12: radar sensors, 13: door opening/closing sensors, 20: side mirror indicators, 21: meter panel, 22: buzzer, 23: speaker.

1. A vehicle control apparatus comprising:
a radar sensor capable of detecting a target present around a vehicle; and
a control unit capable of executing vehicle control when an approaching target which is a target approaching the vehicle is detected by the surrounding sensor, the vehicle control including vehicle-exit assist control for assisting an occupant of the vehicle in a stopped state in safely exiting the vehicle and collision avoidance assist control for assisting in collision avoidance with the approaching target while the vehicle is stopped or traveling,
wherein a detection region of the surrounding sensor includes a plurality of sets of regions, each set of region including a substantially rectangular first region, a substantially rectangular second region, and a substantially rectangular third region,
wherein in any set, a second long side, which is a long side of the second region, is longer than a first long side, which is a long side of the first region, and the second region is positioned at a position more distant from the vehicle than the first region in such a manner that the entire of the first long side, among a pair of the first long sides of the first region, which is positioned at a distal side which is more distant from the vehicle, is in contact with the second long side, among a pair of the second long sides of the second region, which is positioned at a proximal side which is closer to the vehicle, and a third long side, which is a long side of the third region, is longer than the second long side, and the third region is positioned at a position more distant from the vehicle than the second region in such a manner that the entire of the second long side, among the pair of the second long sides of the second region, which is positioned at the distal side, is in contact with the third long side, among a pair of the third long sides of the third region, which is positioned at the proximal side,
wherein the control unit is configured to:
when a predetermined partial wave condition that is satisfied when the detected target is a partial wave which is a wave constituting a part of water wave of seawater is satisfied for the approaching target, even when an execution condition of the vehicle control is satisfied for the approaching target, not execute or suppress the vehicle control corresponding to the execution condition, the water wave being elongated in a direction substantially orthogonal to a traveling direction thereof, and intermittently approaching a coast;
in any set,
in a first case in which a predetermined water wave condition, which is satisfied when water wave is present in at least one of the first region, the second region, or the third region, is satisfied at a current time point and a specific target is present in the first region at the current time point, the specific target being a target satisfying a predetermined specific condition which is satisfied when there is a possibility that a target is the partial wave, determine that the partial wave condition is satisfied for the specific target present in the first region;
in a second case in which the water wave condition is satisfied at any time point during a predetermined past period from a past time point to a current time point, the specific target is present in the second region or the third region at the any time point, and the specific target which had been present in the second region or the third region at the any time point is present in the first region at the current time point, determine that the partial wave condition is satisfied for the specific target present in the first region; and
determine that the water wave condition is satisfied in any one of the following cases, that is, a case in which more than or equal to a predetermined first number of the specific targets are present in the first region, a case in which, in the second region, more than or equal to a predetermined second number of the specific targets are present as well as more than or equal to a predetermined third number of the specific targets are present consecutively, each of the specific targets satisfying that an adjacent distance which is a distance to an adjacent specific target is less than or equal to a predetermined second region distance threshold, or a case in which, in the third region, more than or equal to a predetermined four number of the specific targets are present as well as more than or equal to a predetermined fifth number of the specific targets are present consecutively, each of the specific targets satisfying that the adjacent distance is less than or equal to a predetermined third region distance threshold.

2. (canceled)

3. The vehicle control apparatus according to claim 1, wherein,
the control unit is configured to determine that the specific condition is satisfied for the target in a case in which a relative speed of the target with respect to the vehicle is less than or equal to a predetermined speed threshold, a radar reflection cross-sectional area of the target is less than or equal to a predetermined cross-sectional area threshold, and a detection time which is a time during which the same target is continuously detected by the surrounding sensor is more than or equal to a predetermined time threshold.
